(19) United States
(12) Patent Application Publication
(10) Pub. No.: US 2013/0020139 A1
(43) Pub. Date: Jan. 24, 2013

(54) MOUNTING STRUCTURE FOR BATTERY IN ELECTRIC VEHICLE

(71) Applicants: Minwook Kim, Hwaseong (KR); Dal Kim, Suwon (KR); Shinhyuk Yoon, Hwaseong (KR)

(72) Inventors: Minwook Kim, Hwaseong (KR); Dal Kim, Suwon (KR); Shinhyuk Yoon, Hwaseong (KR)

(73) Assignees: KIA MOTORS CORPORATION, Seoul (KR); HYUNDAI MOTOR COMPANY, Seoul (KR)

(21) Appl. No.: 13/305,209

(22) Filed: Nov. 28, 2011

(30) Foreign Application Priority Data
Jul. 21, 2011 (KR) 10-2011-0072559

(51) Int. Cl. B60K 1/04; B60K 11/06

(52) U.S. Cl. 180/68.5; 180/65.21; 903/952

(57) ABSTRACT

Provided is a mounting structure for a battery in an electric vehicle capable of increasing a driving distance of the electric vehicle by mounting a plurality of battery modules in an existing vehicle body of en electric vehicle. The mounting structure for a battery in an electric vehicle according to an exemplary embodiment of the present invention includes a main relay box electrically connected with an inverter, a plurality of first battery modules mounted beneath the rear seats of the electric vehicle, and a main housing positioned between a pair of front seats in the electric vehicle and below the rear seat. More specifically, the main housing is configured to house the main relay box and first battery modules therein, and is fixed to the vehicle body of the electric vehicle.

### CROSS-REFERENCE TO RELATED APPLICATIONS

The present application claims priority to Korean Patent Application Number 10-2011-0072559 filed Jul. 21, 2011, the entire contents of which application is incorporated herein for all purposes by this reference.

### BACKGROUND OF THE INVENTION

1. Field of the Invention

The present invention relates to a structure in which a battery is mounted inside an electric vehicle, and more particularly, to a mounting structure for a battery in an electric vehicle capable of increasing a driving distance of the electric vehicle by mounting a plurality of battery modules in a vehicle body.

2. Description of Related Art

In recent years, hybrid vehicles and electric vehicles have quite popular due to high oil prices and the environmental impact of purely fuel consumption vehicles. In particular, the hybrid vehicle has become an intermediate choice for those consumers wishing to reduce fuel consumption while at the same time increase their allowable travel distance.

In purely electric vehicles, however, the vehicle's driving force must be provided from a battery in order to receive the energy required for driving the vehicle. Accordingly in order or the battery to supply sufficient power to the motor, a large-capacity battery should be provided.

However, due to a spatial limitation in the vehicle, mounting a large-capacity battery is often problematic. As a result, there have been various attempts to solve this problem. As one example thereof, a technology of mounting a battery module packed in a rectangular shape on a floor of the vehicle body has been suggested. However, in order to secure a space for receiving the battery module on the floor of the vehicle body, an internal space, i.e., foot space, head space, and the like must be reduced thereby inconveniencing the consumer's comfort.

One suggested solution is to manufacture a panel for the vehicle body that is sufficiently sized to as to be capable of receiving the battery module. However, in order to implement such a panel system a new vehicle body platform must be developed. This development increases the cost and time required to develop a new vehicle and thus raises the overall price of a vehicle as well. Additionally, this paneled area may be extremely vulnerable to collisions, and as a result, the vulnerable structure should be improved.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

The present invention has been made in an effort to provide a mounting structure for a battery in an electric vehicle capable of mounting a plurality of large-capacity battery modules in a vehicle body while maximizing the use of unused space in an existing vehicle body.

An exemplary embodiment of the present invention provides a mounting structure for a battery in an electric vehicle including a motor and an inverter in an engine compartment, including a main relay box electrically connected with the inverter; a plurality of first battery modules mounted below rear seats of the electric vehicle; and a main housing positioned between the front seats and below the rear seats, housing the main relay box and the first battery modules therein, and fixed to a vehicle body.

Second battery modules positioned in front of the first battery modules and electrically connected with the main relay box and the first battery modules may be provided in the main housing. The second battery modules may be mounted within a console box between the front seats, and the first battery modules and may be arranged in a T shape. Furthermore, the main relay box may be electrically connected with a rapid charging module and a first cooling fan may be provided at one portion of the main housing.

The mounting structure for a battery in an electric vehicle may further include: third battery modules electrically connected with the first battery modules and installed in a tire well of a vehicle's trunk compartment; and a sub-housing fixed to the inside of the tire well of the vehicle's trunk compartment on the periphery thereof and housing the third battery modules. A second cooling fan may be further provided at one portion of the sub-housing.

According to a mounting structure for a battery in an electric vehicle of an exemplary embodiment of the present invention, battery modules may be mounted (1) between the front seats, (2) underneath the rear seats, and in a tire well of a trunk, respectively thereby maximally using the unused space in an existing vehicle to increase the vehicle's drivable distance per charge.

Advantageously, in spite of mounting a plurality of battery modules in the vehicle, since the verified existing vehicle body is maximally used, cost and time required to develop a new vehicle can be reduced and the price of the vehicle can be maintained. Furthermore, the passenger space is not used to mount the battery module, the passengers' comfort is improved as well.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a side view showing a position where a battery module is mounted in a mounting structure for a battery in an electric vehicle according to an exemplary embodiment of the present invention.

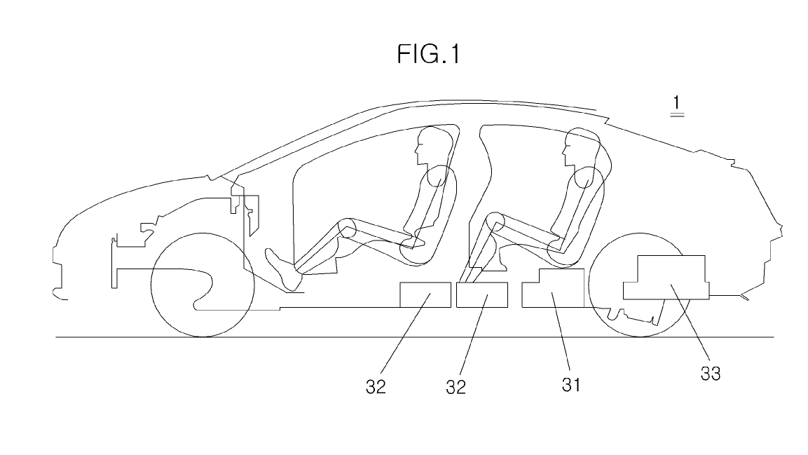

FIG. 2 is a plan view showing the position where the battery module is mounted in the mounting structure for the battery in the electric vehicle according to the exemplary embodiment of the present invention.

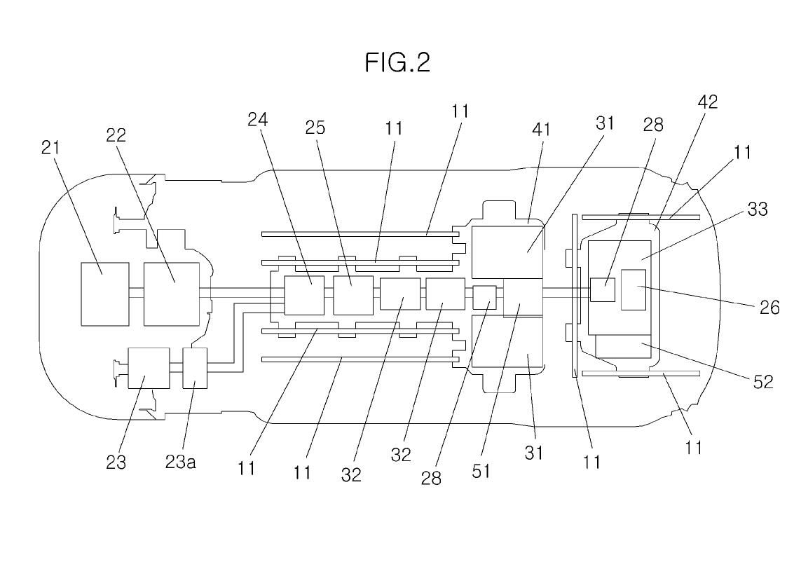

FIG. 3 is a plan view of the mounting structure for the battery in the electric vehicle according to the exemplary embodiment of the present invention.

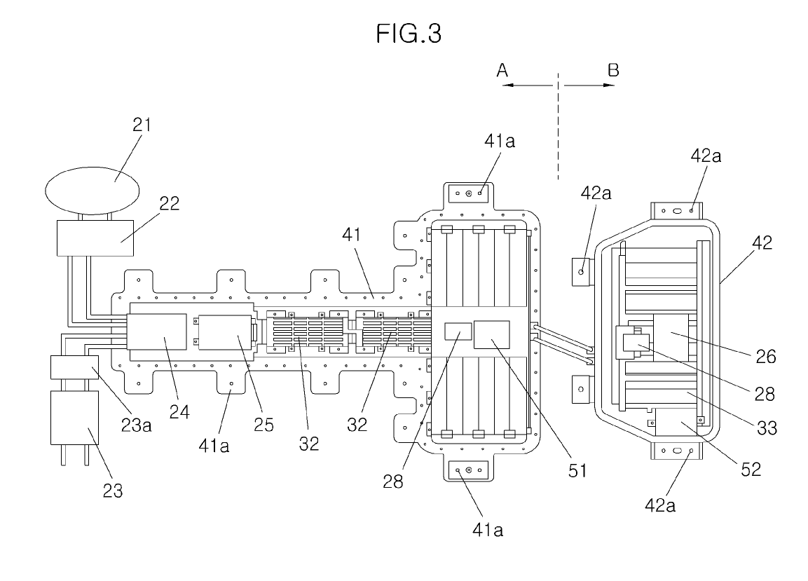

FIG. 4 is a circuit diagram of the mounting structure for the battery in the electric vehicle according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of electric motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum) which would require a battery modules in order to operate. As referred to herein, a hybrid vehicle is a vehicle that has two or more sources of power, for example both gasoline-powered and electric-powered vehicles.

Exemplary embodiments of the present invention are described hereafter in detail with reference to the accompanying drawings, and the exemplary embodiments can be achieved in various ways by those skilled in the art and the present invention is not limited to the exemplary embodiments.

A mounting structure for a battery in an electric vehicle according to an exemplary embodiment of the present invention will be described with reference to the accompanying drawings. The mounting structure for a battery in an electric vehicle according to the exemplary embodiment of the present invention is provided in an electric vehicle that includes a motor 21 and an inverter 22 in an engine compartment, a main relay box 24 electrically connected with inverter 22, a plurality of first battery modules 31 mounted beneath rear seats of the vehicle, and a main housing 41 which is (1) positioned between a pair of front seats and below the rear seats, (2) mounted on a vehicle body, (3) configured to receive a main relay box 24 and first battery modules 31 therein, and (4) fixed to the vehicle body.

According to the mounting structure for a battery in an electric vehicle of the exemplary embodiment of the present invention, a battery module constituted by a plurality of battery cells connected to each other is provided in a plurality as a section for supplying a power source to the motor of the electric vehicle to increase a drivable distance with one-time charging. The motor 21 which is configured to generate a driving force and an inverter 22 which is configured to convert current from the battery into current for driving the motor 21 are provided in a space positioned in front of the vehicle, which is typically called the engine compartment.

A rapid charging module including a rapid charging unit 23 and a sub relay box 23a is provided in the engine compartment for rapid charging while recharging. Rapid charging unit 23 is used during charging through an external power supply of the electric vehicle and sub relay box 23a is electrically connected to main relay box 24 to control charging. Further, main relay box 24 is electrically connected with inverter 22 to control inverter 22. In this case, since motor 21 and inverter 22 are positioned in the engine compartment, main relay box 24 and a main battery management system (BMS) 26 are positioned in-between the front seats of the vehicle.

First battery modules 31 are disposed in a space where a fuel tank would be positioned a typical fuel consumption vehicle. This position is located below the rear seats of the vehicle. Since the fuel tank is not needed and therefore omitted from electric vehicles, first battery modules 31 are positioned in its place. In this case, first battery modules 31 are formed by connecting the plurality of battery cells in series.

Main housing 41 is positioned below a console in a passenger compartment of the vehicle and beneath the rear seats by encompassing a space between the front seats in a compartment of the vehicle so as to have a T shape as a whole. Main housing 41 houses the main relay box 24 and the main BMS 26 in addition to first battery modules 31.

Locking apertures 41a are formed on the periphery of main housing 41, such that main housing 41 is fixed to a vehicle body member 11 formed on a floor of the vehicle body and maintaining rigidity of the vehicle body via locking apertures 41a. A first cooling fan 51 for forcing outdoor air to flow therein is preferably provided at one portion of main housing 41 in order to cool first battery modules 31 which become over heated when actuated.

In order to increase the battery capacity of the vehicle, second battery modules electrically connected with first battery modules 31 are further preferably provided between the front seats. For example, when a vehicle has at least four seats, second battery modules 32 are mounted in a space with the main relay box 24, the main BMS 26, and the first battery modules 31, i.e., the console, to increase the vehicle's driving distance per charge. Second battery modules 32 are also housed in main housing 41 to prevent them from being exposed to external elements. Second battery modules 32 are also housed in the main housing 41 so that they also are sheltered from external elements. Meanwhile, the main housing 41 has the T shape as a whole, and the first battery modules 31 and the second battery modules 32 are housed in the main housing 41, and as a result, the first battery modules 31 and the second battery modules 32 are also arranged in a T shape.

A trunk well for storing a spare tire is typically formed within one portion of a trunk compartment in a typical sedan type vehicle. In this type of vehicle, the battery modules may additionally be mounted in the trunk well as well to maximize the capacity of the battery mounted on the electric vehicle.

Third battery modules 33 are also arranged by placing the plurality of battery cells in series. Third battery modules 33 are electrically connected with first battery modules 31 and second battery modules 32 to maximize the battery capacity of the electric vehicle. A sub-housing 42 is fixed to the vehicle body and houses third battery modules 33. Sub-housing 42 is positioned in the trunk of the vehicle where the spare tire is typically stored. Locking apertures 42a are formed evenly at predetermined distances on the periphery of sub-housing 42, so that the sub-housing 42 may be fixed to vehicle body member 11 by using the locking apertures 42a when the sub-housing 42 is positioned in the tire well of the trunk compartment.

A second cooling fan 52 for allowing/forcing outdoor air to flow through the sub-housing and/or the other housing in the battery structure may be provided within one portion of sub-housing 42 in order to cool third battery modules 33. A sub BMS 26 for controlling the third battery modules 33 housed in the sub-housing 42 and a fuse for protecting a circuit are provided.

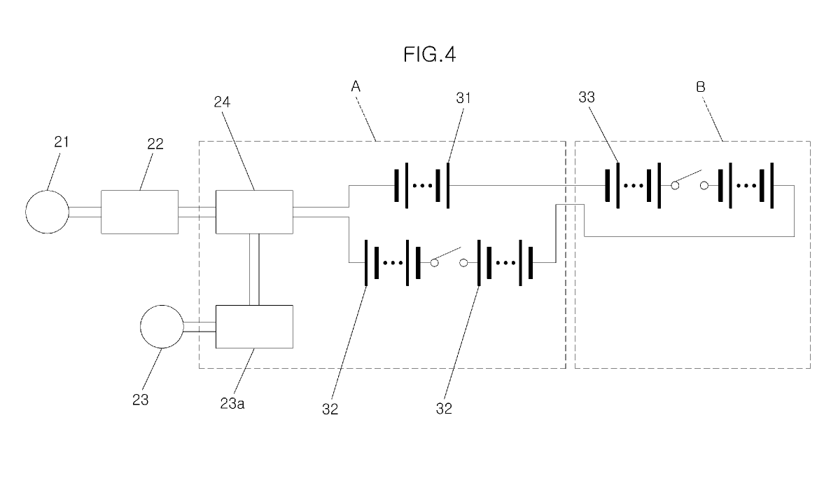

In the mounting structure for the battery in the electric vehicle according to the exemplary embodiment of the present invention, the electrical connection relationship among plurality of first battery modules 31, second battery modules 32, and third battery modules 33 is shown in FIG. 4. Since first battery modules 31 and second battery modules 32 are positioned relatively more towards the front of the vehicle than the third battery modules 33 positioned in the trunk, the first and second battery modules become front battery modules A and third battery modules 33 become rear battery modules B.

According to the mounting structure for the battery in the electric vehicle of the exemplary embodiment of the present invention, the capacity of the battery module kept in a vehicle body can be maximized by efficiently using the vehicle body as it exists rather than forming an additional panel to house the battery. That is, by using an idle space in the vehicle, the battery which can be mounted on vehicle 1 can be maximized without reducing the amount of passenger space provided.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A mounting structure for a battery in an electric vehicle including a motor and an inverter in an engine compartment, the mounting structure comprising:
a main relay box electrically connected with the inverter;
a plurality of first battery modules mounted beneath rear seats of the electric vehicle; and
a main housing positioned between front seats and beneath the rear seats of the electric vehicle, wherein the main housing houses the main relay box and the first battery modules therein, and is fixed to a vehicle body of the electric vehicle.

2. The mounting structure for a battery in an electric vehicle as defined in claim 1, wherein second battery modules positioned in front of the first battery modules and electrically connected with the main relay box and the first battery modules are disposed in the main housing.

3. The mounting structure for a battery in an electric vehicle as defined in claim 2, wherein the second battery modules are mounted in a console between the front seats, and the first battery modules and the second battery modules are arranged in a T shape.

4. The mounting structure for a battery in an electric vehicle as defined in claim 1, wherein the main relay box is electrically connected with a rapid charging module.

5. The mounting structure for a battery in an electric vehicle as defined in claim 1, wherein a first cooling fan is disposed within at least one portion of the main housing.

6. The mounting structure for a battery in an electric vehicle as defined in claim 1, further comprising:
third battery modules electrically connected with the first battery modules and installed in a tire well of a vehicle's trunk compartment; and
a sub-housing locked to the inside of the tire well of the vehicle's trunk compartment, on a periphery thereof and configured to house the third battery modules.

7. The mounting structure for a battery in an electric vehicle as defined in claim 6, wherein a second cooling fan is further disposed within at least one portion of the sub-housing.

8. A mounting structure for a battery comprising:
a main relay box electrically connected with an inverter installed in a vehicle body of an electric vehicle;
a plurality of first battery modules mounted beneath rear seats of the electric vehicle; and
a main housing positioned between front seats and beneath the rear seats of the electric vehicle to thereby form a T-shaped housing, wherein the main housing houses the main relay box and the first battery modules therein, and is fixed to a portion of the vehicle body of the electric vehicle.

9. The mounting structure for a battery in an electric vehicle as defined in claim 8, wherein second battery modules positioned in front of the first battery modules and electrically connected with the main relay box and the first battery modules are disposed in the main housing.

10. The mounting structure for a battery in an electric vehicle as defined in claim 9, wherein the second battery modules are mounted in a console between the front seats, and the first battery modules and the second battery modules are arranged in a T shape.

11. The mounting structure for a battery in an electric vehicle as defined in claim 8, wherein the main relay box is electrically connected with a rapid charging module.

12. The mounting structure for a battery in an electric vehicle as defined in claim 8, wherein a first cooling fan is disposed within at least one portion of the main housing.

13. The mounting structure for a battery in an electric vehicle as defined in claim 8, further comprising:
third battery modules electrically connected with the first battery modules and installed in a tire well of a vehicle's trunk compartment; and
a sub-housing locked to the inside of the tire well of the vehicle's trunk compartment, on a periphery thereof and configured to house the third battery modules.

14. The mounting structure for a battery in an electric vehicle as defined in claim 13, wherein a second cooling fan is further disposed within at least one portion of the sub-housing.
